(19) United States
(12) Patent Application Publication
(10) Pub. No.: US 2022/0072683 A1
(43) Pub. Date: Mar. 10, 2022

(54) Spray unit with a rotatable nozzle as well as a blasting device

(71) Applicant: Kalfsvel Materieel B.V., Zaandam (NL)

(72) Inventor: Cornelis Otto KALFSVEL, Krommenie (NL)

(21) Appl. No.: 17/200,834

(22) Filed: Mar. 14, 2021

(30) Foreign Application Priority Data
Jan. 13, 2020 (NL) NL 2024659

(51) Int. Cl. B24C 5/04; B24C 3/06

(52) U.S. Cl. CPC B24C 5/04; B05B 3/0486; B24C 3/06

(57) ABSTRACT

A blasting device has a spray unit for spraying blasting agent onto the surface to be treated. The spray unit has an insert 23′ in which a nozzle 13′ is rotatable. This nozzle 13′ is provided with a number of spray channels 19′ which are at an angle 21′ relative to the supply direction 17 of the blasting agent. The blasting agent is pressed through the spray channels 19′ under pressure and exerts a force on the wall of the spray channels 19′ causing the nozzle 13′ to rotate. The jets emerging from the rotating nozzle 13′ will make a rotating movement. The joint area of the cross-sections of the spray channels 19′ is larger than one third of the cross-sectional area of the circular-cylindrical part of the nozzle. The angle 21′ at which the spray channels are located with respect to the supply direction 17 of the blasting agent is greater than zero and less than 10 degrees.

### TECHNICAL FIELD OF THE INVENTION

The invention relates to spray unit for use in a blasting device for treating a surface, by spraying blasting agent under pressure on the surface to be treated, which spray unit is provided with a housing, as well as a nozzle being rotatably in the housing about an imaginary axis parallel to the supply direction of the blasting agent, and being provided with a number of spray channels that are angled with respect to the direction of feed of the blasting agent, the main part of the nozzle having a circular-cylindrical shape, and the nozzle being provided with an entry side where the blasting agent enters the spray channels and an exit side where the blasting agent leaves the spray channels.

In such a spray unit, the blasting agent will exert a force on the wall of the spray channel, causing the nozzle to rotate. As a result, the jets from the nozzle will also make a rotating movement, resulting in a surface treatment.

### BACKGROUND OF THE INVENTION

A blasting device provided with such a nozzle is known from FR2876599A. This known blasting device is suitable for wet blasting surfaces with a blasting agent of ceramic pearls or glass beads mixed with water. Because the nozzle and therefore the spray jet rotate continuously during spraying, the surface is evenly blasted.

The food and pharmaceutical industry places high demands on the cleanliness and cleanability of the surface of the production equipment. Various studies have shown that wet blasting (for example with ceramic or glass beads mixed in water), as an alternative to dry blasting (ceramic or glass beads without water), can meet these requirements.

The cleanliness and cleanability of a surface is determined by its roughness and is measured and expressed in the Ra value (the average surface roughness). If the Ra value is above 0.6 micrometers, contaminants adhere to the surface more easily and can even be included.

In dry blasting, an impact occurs through a ceramic particle or a glass bead. To the eye, the surface appears smooth after this treatment, but at the micro level the impact causes relatively high peaks and dips. In the wet blasting no impact takes place, but a flow of liquid containing solid particles along the surface provides for the surface treatment and thereby removes the higher peaks. This ensures a better result. However, to avoid stains caused by not blasting evenly over the entire surface, the spray unit should be continuously rotated. This is very critical, so that in practice staining as a result of differences in intensity of the treatment is virtually unavoidable.

### SUMMARY OF THE INVENTION

It is an object of the invention to provide a spray unit of the type described in the preamble with which the treatment produces an even smoother and better surface than is the case after treatment with the known blasting device and whereby staining is effectively prevented. For this purpose the spray unit according to the invention is characterized in that the joint area of the cross-sections of the spray channels at right angles to the imaginary axis at the exit side is greater than one third of the area of the cross-section of the circular-cylindrical part of the nozzle perpendicular to the imaginary axis. Due to the larger spray channels, more blasting agent can be blasted per unit time at the same pressure, which leads to a better cleaning process.

Preferably, that the angle at which the spray channels are located with respect to the supply direction of the blasting agent is greater than zero and less than 10 degrees. Due to the small angle, the rotation speed remains limited, which leads to an even better cleaning process.

The cleanability after treatment of a surface with the blasting device according to the invention is not only better, but the cleaning is also faster, so that less valuable production time is lost for cleaning production equipment.

An embodiment of the spray unit according to the invention is characterized in that the nozzle is further provided with a further spraying channel which is present in the center of the nozzle and is parallel to the blasting agent supply direction. By spraying the blasting agent in addition to these rotating jets with a non-rotating straight jet on the surface to be treated, this extra jet will also remove stubborn impurities and irregularities.

In order to obtain a less malfunction-prone operation of the nozzle, the spray unit is provided with an insert which is fixed in the housing, the nozzle being rotatable in the insert. As a result, precise manufacture of the insert will suffice and no high requirements need to be imposed on the dimensional accuracy of the housing. Only on the inside of the insert, in which the nozzle is incorporated, high requirements need to be set with regard to accuracy.

A further embodiment of the spray unit according to the invention is characterized in that the nozzle is provided with two axial end faces and a lateral surface extending there between, and that the insert is provided with a through hole in which the nozzle is rotatable, which hole is delimited by an inner side of the insert, whereby there is play between the mantle surface of the nozzle and the inside of the insert. During use, blasting agent will hit between the mantle surface of the nozzle and the inside of the insert. The play between the mantle surface and the inside must be large enough to prevent the blasting agent from becoming trapped and blocking the nozzle against rotation.

In order to suffice with a smaller play between the insert and the nozzle without increasing the risk of jamming, a still further embodiment of the spray unit according to the invention is characterized in that the inner side of the insert is provided with recesses which are distributed over the circumference at a mutual distance from each other and which extend over the entire thickness of the nozzle. During use of the spray unit, the blasting agent is forced out of the gap between the insert and the nozzle into the recesses and through these recesses the blasting agent can run out of the insert, so that the blasting agent cannot get trapped between the insert and the nozzle and therefore the nozzle cannot block against rotation.

It is noted that a spray unit in which recesses in the inside of the insert extending over the entire thickness can advantageously be used in combination with any nozzle, irrespective of the number, size of the diameter and angle of inclination of the spray channels.

The invention also relates to a blasting device provided with a spray unit according to any one of the preceding claims, for treating a surface by spraying blasting agent under pressure on the surface to be treated, comprising:
a container for the blasting agent,
a blasting agent line through which the spray unit is connected to the container, and
a supply unit for supplying the blasting agent from the container to the spray unit, which supply unit is connected to the blasting agent line between the container and the spray unit.

In the embodiment suitable for wet blasting, the supply unit is preferably provided with a water connection to which a water pipe can be connected and the supply unit is provided with a mixing unit for mixing the blasting agent with water. Furthermore, the supply unit is preferably provided with a compressed air connection to which a compressed air line can be connected which supplies the mixture of blasting agent and water in the case of wet blasting or in the case of dry blasting the dry blasting agent to the spray unit.

### BRIEF DESCRIPTION OF THE DRAWINGS

The invention will be explained in more detail below with reference to exemplary embodiments of the blasting device and the spray unit shown in the drawings. In the drawings:

FIG. 1 is a schematic representation of an embodiment of the blasting device according to the invention which is suitable for wet blasting;

FIG. 2 is an embodiment of the blasting device according to the invention which is suitable for dry blasting;

FIG. 3 is an example of a spray unit for a blasting device in perspective;

FIG. 4 is the spray unit shown in FIG. 3 in side view;

FIG. 5 is an example of an insert with a nozzle therein in cross section;

FIG. 6 is the insert shown in FIG. 5 with the nozzle therein in top view;

FIG. 7 is the insert shown in FIG. 5 in cross section;

FIG. 8 is a side view of the nozzle shown in FIG. 5;

FIG. 9 is an embodiment of the insert with therein the nozzle of the spray unit according to the invention in cross section;

FIG. 10 is the insert with nozzle shown in FIG. 9 in top view;

FIG. 11 is the insert shown in FIG. 9 in cross section; and

FIG. 12 is the nozzle shown in FIG. 9 in side view.

### DETAILED DESCRIPTION OF THE DRAWINGS

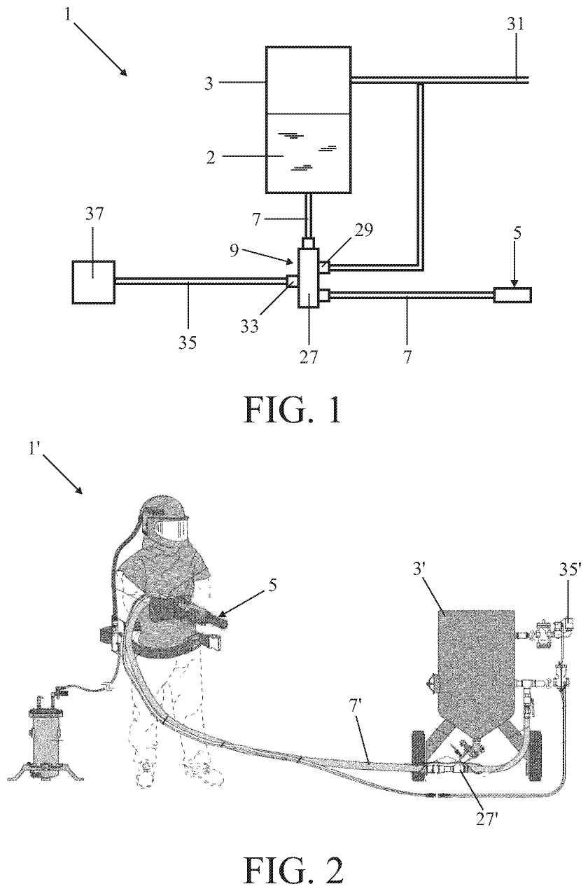

FIG. 1 is a schematic representation of an embodiment of the blasting device according to the invention which is suitable for wet blasting. The blasting device 1 has a container 3 in which blasting agent 2 is present. The blasting agent 2 is formed by fine-grained material mixed with water. The fine-grained material is, for example, ceramic grains or glass beads. The blasting device 1 further has a spray unit 5 for spraying the blasting agent under pressure onto a surface to be treated. This spray unit 5 is connected to the container 3 via a blasting agent line 7. A supply unit 9 accommodated in the blasting agent line 7 between the container and the spray unit ensures the supply of the blasting agent 2 from the container 3 to the spray unit 5.

The supply unit 9 has a mixing unit 27 for mixing the blasting agent 2 with water and is provided for this purpose with a water connection 29 to which a water pipe 31 is connected. This water pipe 31 is also connected to the container 3, so that a control can ensure that a correct ratio of solid particles and liquid is present in the container to prevent the solid particles from forming a compact mass, so that they no longer flow via the blasting agent line 7 but could flow via the mixing unit 27. The supply unit 9 further has a compressed air connection 33 to which a compressed air line 35 is connected which supplies the mixture of blasting agent and water to the spray unit 5.

FIG. 2 shows another embodiment of the blasting device 1 according to the invention. This embodiment is suitable for dry blasting. In that case the blasting agent only has dry fine-grained material such as ceramic grains or glass pearls. In this case the mixing unit 27′ is also present near the outflow opening of the container 3′, but the blasting agent is entrained by air from compressed air line 35′ and fed to the spray unit 5 via the blasting agent line 7′.

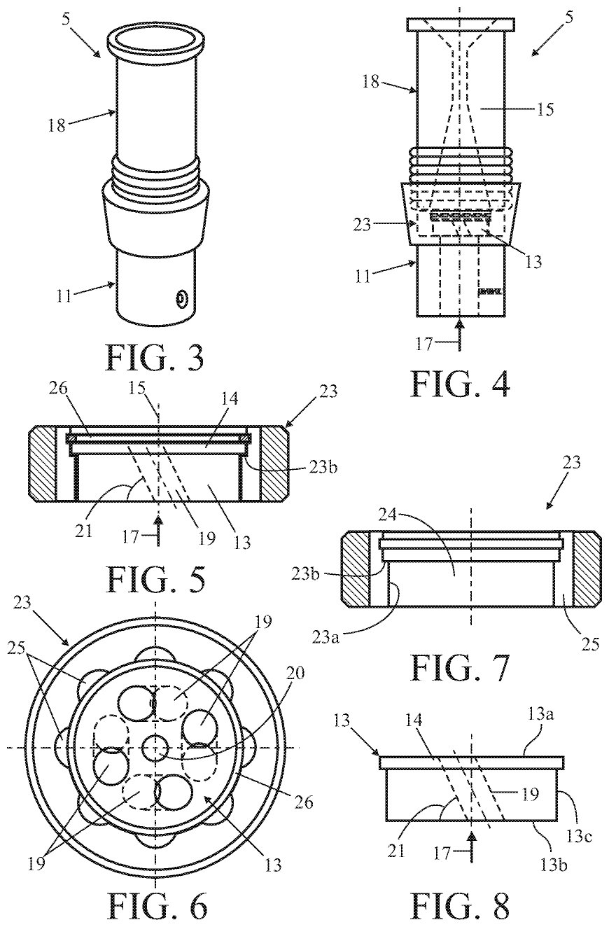

In FIGS. 3 and 4, the spray unit 5, which is suitable for both wet blasting (FIG. 1) and dry blasting (FIG. 2), is shown in perspective and side view, respectively. The spray unit 5 has a housing 11 with a nozzle 13 rotatably present therein. During spraying, the nozzle rotates about an imaginary axis 15 parallel to the supply direction 17 of the blasting agent. A guide 18 is provided on the housing 11 which guides the jets of the blasting agent exiting the nozzle and bends it in a desired direction. The nozzle 13 is rotatable in an insert 23 which is clamped in the housing 11 by means of the guide 18 screwed into the housing 11.

FIGS. 5 and 6 show an example of the insert 23 with the nozzle 13 therein in cross-section and top view, respectively. The nozzle 13 is provided with two axial end faces 13a, 13b and a lateral surface 13c extending there between. The insert 23 is provided with a through hole 24 in which the nozzle 13 is rotatably present. The cylindrical mantle surface 13c of the nozzle 13 slides along the cylindrical inner wall 23a of the insert 23 during spraying. To limit friction and wear, the insert is preferably of Teflon or another suitable material and the nozzle is preferably of hardened steel or other hard metal.

The nozzle 13 is provided with a protruding ridge 13B which, in the direction of feed 17 of the blasting agent, is rotatably enclosed between an edge 23b of the insert 23 and a retaining ring 26.

In order to prevent the nozzle 13 from jamming in the insert 23 during use, play is present between the mantle surface 13c of the nozzle and the inside 23a of the insert. For this purpose, the inner side 23a of the insert 23 is further provided with recesses 25 which are distributed over the circumference at a mutual distance from each other. These recesses extend over the entire thickness of the insert 23 and in this embodiment have a semi-circular cross-section.

In FIGS. 7 and 8 the insert 23 and the nozzle 13 are shown separately in section and bottom view, respectively. The nozzle 13 is provided with a number of spray channels 19 which are at an angle 21 with respect to the supply device 17 of the blasting agent. The blasting agent is pressed through the spray channels 19 under pressure and exerts a force on the wall of the spray channels 19, causing the nozzle 13 to rotate. Since the insert 23 is secured against rotation by the guide 18, the nozzle 13 in the insert 23 will start to rotate. The jets emerging from the rotating nozzle 13 will also make a rotating movement, so that a better jet effect is obtained.

In order to be able to properly remove stubborn dirt and irregularities, the nozzle 13 is also provided with a further spray channel 20 which is present in the center of the nozzle. This further spray channel 20 extends parallel to the delivery device of the blasting agent.

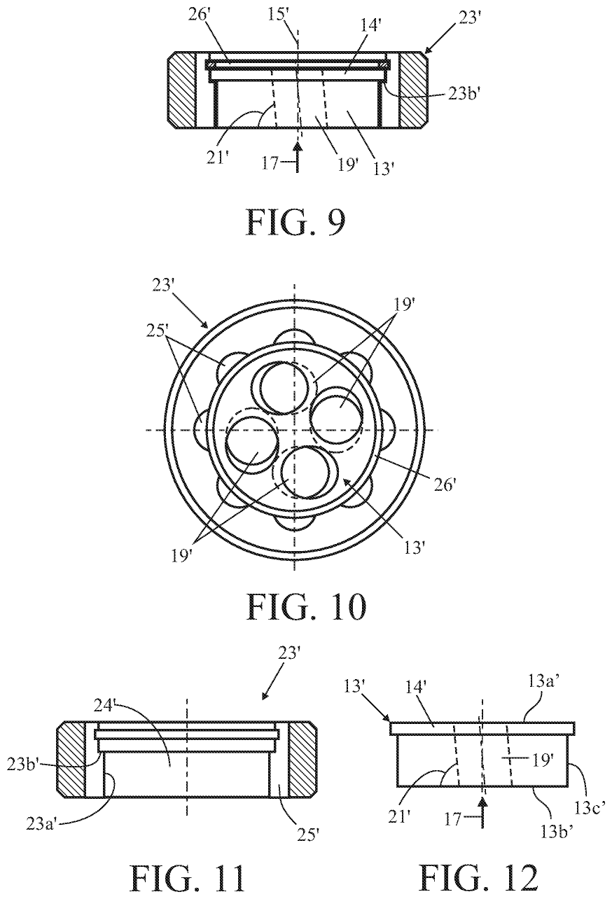

In FIGS. 9 and 10 an embodiment of the insert 23′ with the nozzle 13′ of the spray unit according to the invention therein is shown in cross-section and top view, respectively. In FIG. 11 the insert 23′ is shown separately in cross-section and in FIG. 12 the nozzle 13′ is shown separately in side view. The nozzle 13′ is provided with two axial end faces 13a′, 13b′ and a lateral surface 13c′ extending there between. The insert 23′ is provided with a through hole 24′ in which the nozzle 13′ is rotatable. The nozzle 13′ is provided with a protruding ridge 13B′ which, in the feed direction 17 of the blasting agent, is rotatably enclosed between an edge 23b′ of the insert 23′ and a retaining ring 26.

In order to prevent the nozzle 13′ from jamming in the insert 23′ during use, there is play between the mantle surface 13c of the nozzle and the inside 23a of the insert, and the inside 23a′ of the insert 23′ is provided with recesses 25′ that are distributed over the circumference at a mutual distance from each other. These recesses extend over the entire thickness of the insert 23′ and in this embodiment have a semi-circular cross-section.

The nozzle 13′ is provided with a number of nozzles 19′ which are at an angle 21′ relative to the feed device 17 of the blasting agent. The blasting agent is pressed through the nozzles 19′ under pressure and exerts a force on the wall of the nozzles 19′, causing the nozzle 13′ to rotate. The jets emerging from the rotating nozzle 13′ will also make a rotating movement, resulting in a better jet effect. Good results are obtained with a nozzle in which the nozzles 19′ at an angle 21′ of 1 to 7 degrees are present. In the embodiment shown, the nozzles 19′ are present at an angle 21′ of 5 degrees.

Although the present invention is elucidated above on the basis of the given drawings, it should be noted that this invention is not limited whatsoever to the embodiments shown in the drawings. The invention also extends to all embodiments deviating from the embodiments shown in the drawings within the scope of the invention defined by the appended claims.

1. Spray unit for use in a blasting device for treating a surface, by spraying blasting agent under pressure on the surface to be treated, which spray unit is provided with a housing, as well as a nozzle being rotatably in the housing about an imaginary axis parallel to the supply direction of the blasting agent, and being provided with a number of spray channels that are angled with respect to the direction of feed of the blasting agent, the main part of the nozzle having a circular-cylindrical shape, and the nozzle being provided with an entry side where the blasting agent enters the spray channels and an exit side where the blasting agent leaves the spray channels, wherein the joint area of the cross-sections of the spray channels at right angles to the imaginary axis at the exit side is greater than one third of the area of the cross-section of the circular-cylindrical part of the nozzle perpendicular to the imaginary axis.

2. Spray unit according to claim 1, wherein the angle at which the spray channels are located with respect to the supply direction of the blasting agent is greater than zero and less than 10 degrees.

3. Spray unit according to claim 1, wherein the nozzle is further provided with a further spraying channel which is present in the center of the nozzle and is parallel to the blasting agent supply direction.

4. Spray unit according to claim 1, wherein the spray unit is further provided with an insert which is fixed in the housing, the nozzle being rotatable in the insert.

5. Spray unit according to claim 4, wherein the nozzle is provided with two axial end faces and a lateral surface extending there between, and that the insert is provided with a through hole in which the nozzle is rotatable, which hole is delimited by an inner side of the insert, whereby there is play between the mantle surface of the nozzle and the inside of the insert.

6. Spray unit according to claim 5, wherein the inner side of the insert is provided with recesses which are distributed over the circumference at a mutual distance from each other and which extend over the entire thickness of the nozzle.

7. Blasting device provided with a spray unit according to claim 1, for treating a surface by spraying blasting agent under pressure on the surface to be treated, comprising:
a container for the blasting agent,
a blasting agent line through which the spray unit is connected to the container, and
a supply unit for supplying the blasting agent from the container to the spray unit, which supply unit is connected to the blasting agent line between the container and the spray unit.

8. Blasting device according to claim 7, wherein the supply unit is provided with a water connection to which a water pipe can be connected and the supply unit comprises a mixing unit for mixing the blasting agent with water.

9. Blasting device according to claim 7, wherein the supply unit is provided with a compressed air connection to which a compressed air line can be connected, which supplies the mixture of blasting agent and water to the spray unit.
